(19) United States
(12) Patent Application Publication
(10) Pub. No.: US 2002/0126700 A1
(43) Pub. Date: Sep. 12, 2002

(54) Transmission techniques using universal data link protocol

(76) Inventor: Yoshinori Rokugo, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/798,906

(22) Filed: Mar. 6, 2001

(30) Foreign Application Priority Data
Mar. 6, 2000 (JP) 061288/2000

(51) Int. Cl. H04L 12/28; H04L 12/56; H04J 3/16

(52) U.S. Cl. 370/469

(57) ABSTRACT

A virtual frame using the universal data link (UDL) protocol to allow efficient consolidation of UDL frames and ATM cells is disclosed. A virtual frame for common use in both a physical layer and a data link layer includes a universal data link (UDL) frame and an ATM (asynchronous transfer mode) cell. The UDL frame is composed of a fixed-size header and a variable-size payload. The fixed-size header of the UDL frame includes a length (LEN) field indicating a length of the UDL frame, a frame identification (FID) field, and a frame header error check (FHEC) field. The FHEC is calculated from the LEN and the FID according to a predetermined computation method.

### BACKGROUND OF THE INVENTION

1. Field of the Invention

The present invention relates to a transmission network such as a light-wave network, and in particular to an improved multiplexing technique allowing integration of different networks.

2. Description of the Related Art

With the recent vast increase in data traffic, the demand for large-capacity high-speed transmission lines is increasingly growing. Under such circumstances, various networks are now constructed, such as STM (synchronous transfer mode) network, ATM (asynchronous transfer mode) network, and IP (Internet Protocol) network. Especially, with the skyrocketing amount of traffic on the Internet, ATM network provides a system taking IP data transmission into consideration, for example, IP over ATM by encapsulating IP packets using AAL5 protocol.

However, such a situation that a plurality of different networks are independently managed and operated causes construction, management, and maintenance of networks to be complicated.

Further, in the case of transmission of signals having different formats, such as IP packet and ATM cell, the bandwidth of the network cannot be efficiently used. For example, wavelength division multiplexing (WDM) techniques that have been widely employed in photonic networks are expected to provide an integrated network. However, since predetermined bandwidths are previously allocated for different signal formats, an increased amount of wavelength resource is occupied and further it is impossible to cope with changes in bandwidth required for ATM cell transfer and IP packet transfer, resulting in reduced efficiency of use.

Therefore, it is indispensable to accommodate the different networks (e.g. STM, ATM, and IP) in a single network and provide a novel scheme capable of meeting the requirement of speedups with flexibility. In addition, there has been also considered the case of no physical-layer frame such as metropolitan-area WDM.

Under the above-described circumstances, a novel data link protocol has been proposed in Japanese Patent Application No. 2000-35584 (filed on Feb. 14, 2000, by the present Applicant). This novel data link protocol allows efficient multiplexing of ATM cells and layer-3 traffic such as IP packet and/or layer-2 frames on the same carrier wave. A frame according to this novel data link protocol is hereafter called Universal Data Link (UDL) frame.

### SUMMARY OF THE INVENTION

It is an object of the present invention to provide a method and system using the universal data link (UDL) protocol to allow efficient consolidation of UDL frames and ATM cells.

It is another object of the present invention to a method and system using the UDL protocol to ensure data transparency.

According to the present invention, a virtual frame is defined, which conveys at least one UDL frame and at least one ATM cell. A self synchronized scrambling scheme is employed to ensure data transparency.

According to an aspect of the present invention, a virtual frame having a predetermined period, for common use in both a physical layer and a data link layer, includes: a universal data link (UDL) frame comprising a fixed-size header and a variable-size payload; and an ATM (asynchronous transfer mode) cell, wherein the fixed-size header of the UDL frame includes a length (LEN) field indicating a length of the UDL frame, a frame identification (FID) field, and a frame header error check (FHEC) field, wherein the FHEC is calculated from the LEN and the FID according to a predetermined computation method.

The FHEC may allow UDL frame delineation to be performed independently of ATM cell delineation. The FHEC 13 may be located at a predetermined position of the fixed-size header, wherein a combination of the LEN and the FHEC is used for the UDL frame delineation.

The variable-size payload may include an extended frame header error check field, a payload data field, and a payload-CRC (cyclic redundancy check) field.

Tho virtual frame may further include an idle packet for filling in free space in the virtual frame. The idle packet may be a UDL frame consisting of the fixed-size header. The virtual frame may further include an OAM (Operations, Administration, and Maintenance) packet for filling in free space in the virtual frame.

The UDL frame and the ATM cell may be arranged in the virtual frame in accordance with priorities for each virtual frame.

According to another aspect of the present invention, a transmitter for use in the transmission system includes: a multiplexer for multiplexing a plurality of UDL frames and OAM packets and/or stuff packets so that the OAM packets and/or stuff packets fill in free space among the UDL frames, to produce a virtual frame having a constant period; and a self-synchronized scrambler for scrambling the virtual frame before transmitting.

According to an embodiment of the present invention, a transmitter includes: a first buffer for storing a plurality of ATM cells mapped from an upper layer in accordance with priorities: a second buffer for storing a plurality of UDL packets mapped from an upper layer in accordance with priorities; a third buffer for storing a plurality of OAM packets and/or stuff packets; a multiplexer for arranging a plurality of ATM cells sequentially read out from the first buffer and a plurality of UDL packets sequentially read out from the second buffer in a virtual frame having a constant period according to priorities, wherein OAM packets and/or stuff packets sequentially read out from the third buffer fill in free space among the UDL packets and the ATM cells; and a self-synchronized scrambler for randomizing the virtual frame before transmitting.

A receiver includes: a self-synchronized descrambler for descrambling a scrambled data sequence received from a transmitter to produce a virtual frame using a clock extracted from the received scrambled data sequence, wherein the scrambled data sequence has been produced by a self-synchronized scrambler scrambling an original virtual frame according to a predetermined scrambling scheme; a demultiplexer for demultiplexing the virtual frame into a plurality of UDL frames, a plurality of ATM cells, and OAM packets and/or stuff packets filling in free space among the UDL frames and ATM cells, wherein the stuff packets are discarded; a first buffer for storing the ATM cells in accordance with priorities; a second buffer for storing the UDL packets in accordance with priorities; and a third buffer for storing the OAM packets.

### BRIEF DESCRIPTION OF THE DRAWINGS

FIG. 1 is a diagram showing a format of a universal data link frame;

FIG. 2 is a diagram showing an example of a virtual frame according to the present invention;

FIG. 3 is a diagram showing a communication system according to an embodiment of the present invention; and

FIG. 4 is a block diagram illustrating a typical example of scrambler/descrambler for use in the embodiment of the present invention.

### DETAILED DESCRIPTION OF THE PREFERRED EMBODIMENT

First of all, a universal data link (UDL) frame used in the present invention will be described.

### UDL FRAME FORMAT

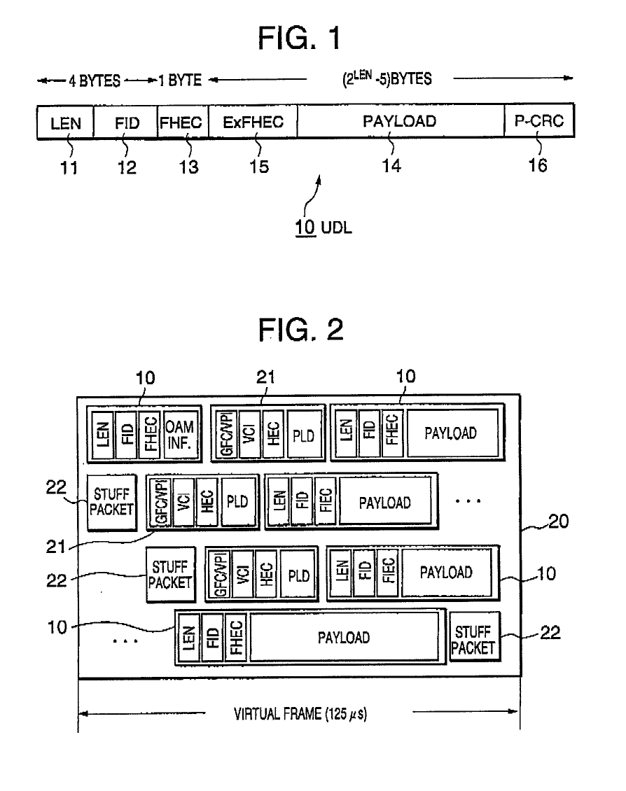

As shown in FIG. 1, a UDL packet 10 is a variable-length packet that is composed of a 5-byte header and a (2^{LEN}-5)-byte payload with a minimum size of 5 bytes and a maximum size of 2^{LEN} bytes.

The 5-byte header is composed of a length (LEN) field 11, a frame identification (FID) field 12, and a 1-byte frame header error check (FHEC) field 13. The LEN 11 indicates a length (LEN) of the UDL frame, which determines the maximum size (2^{LEN} bytes) of the UDL packet 10. There is a total of 4 bytes in the LEN 11 and the FID 12.

The 1-byte FHEC 13 provides error checking/correcting of the header. The FHEC 13 is located at fifth byte of the header. Further, a combination of the FHEC 13 and the LEN 11 is used for frame delineation. It should be noted that the coding computation of the FHEC 13 is designed to be different from that of ATM HEC. Therefore, UDL frame delineation can be performed independently of ATM cell delineation.

The (2^{LEN}-5)-byte payload may consist of an extended frame header error check (ExFHEC) field 15, a payload data field (payload) 14, and payload-CRC (cyclic redundancy check) field (P-CRC) 16.

### VIRTUAL FRAME

Referring to FIG. 2, a virtual frame 20 is defined as a frame having a constant period of, for example, 125 μsec, that includes a plurality of UDL packets 10 as described above and ATM cells 21 and further includes stuff packets 22 and/or OAM (Operations, Administration and Maintenance) packets as necessary.

An ATM cell 21 is, as well known, a fixed-size (53 bytes) packet composed of a 5-byte header and a 48-byte payload. The 5-byte header includes GFC (general flow control) field, VPI (virtual path identifier) field, VCI (virtual channel identifier) field, and HEC (header error check) field. The cell HEC detects and corrects errors in the header and, as described before, is used for cell delineation. As describe later, UDL packets 10 and ATM cells 21 are multiplexed according to priority control.

A stuff packet 22 is an idle packet or a minimum-sized (5-byte) UDL packet. The stuff packet 22 is used to fill in free space left in the virtual frame.

### TRANSMISSION SYSTEM

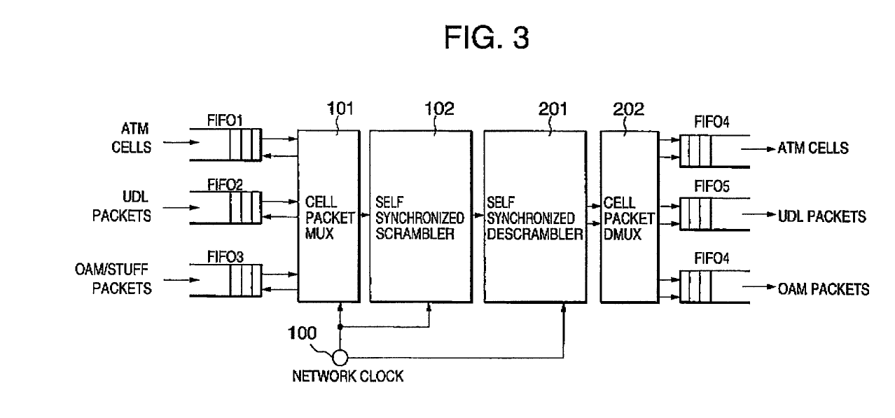

Referring to FIG. 3, a transmitter at a sending side includes FIFO (First-in-first-out) memories 1-3, a cell packet multiplexer 101, and a self-synchronized scrambler 102. A receiver at a receiving side includes a self-synchronized descrambler 201, a cell packet demultiplexer 202, and FIFO memories 406. A network clock 100 is used by the cell packet multiplexer 101 and the self-synchronized scrambler 102 in the sending side and the self-synchronized descrambler 201 in the receiving side.

At the sending side, a plurality of ATM cells that are mapped according to priorities from the upper layer are temporarily stored in the FIFO memory 1, a plurality of UDL packets that are mapped according to priorities from the upper layer are temporarily stored in the FIFO memory 2, and a plurality of OAM packets and stuff packets are temporarily stored in the FIFO memory 3.

The cell packet multiplexer 101 sequentially reads out an ATM cell, a UDL packet and an OAM packet or stuff packet from respective ones of the FIFO memories 1-3 according to the network clock 100 and multiplexes ATM cells 21 and UDL packets 10 according to the priorities and further multiplexes OAM packets or stuff packets 22 so as to fill in free space in a virtual frame 20. Since ATM cells and UDL packets are arranged in sequence taking priorities into consideration, Quality of Service (QoS) can be ensured. In this manner, ATM cells and UDL packets are multiplexed with OAM or stuff packets filling in free space to produce a virtual frame 20 as shown in FIG. 2.

The virtual frame 20 is output to the self-synchronized scrambler 102 to be randomized and the randomized virtual frame is sent to the receiving side according to the network clock 100. In this way, virtual frames are sent in a constant period.

At the receiving side, after extracting the network clock 100 from received data, the self-synchronized descrambler 201 descrambles the randomized data to reproduce an original virtual frame according to the network clock 100. The cell packet demultiplexer 202 looks at the FHEC 13 for frame delineation and the ATM HEC for cell delineation to demultiplex the reproduced virtual frame into ATM cells 21, UDL packets 10, and OAM packets while keeping the priorities. The stuff packets 22 are discarded. The ATM cells 21 are stored into the FIFO memory 4 to be mapped to the upper layer. The UDL packets 10 are stored into the FIFO memory 5 to be mapped to the upper layer. The OAM packets are stored into the FIFO memory 6.

### SELF-SYNC SCRAMBLER/DESCRAMBLER

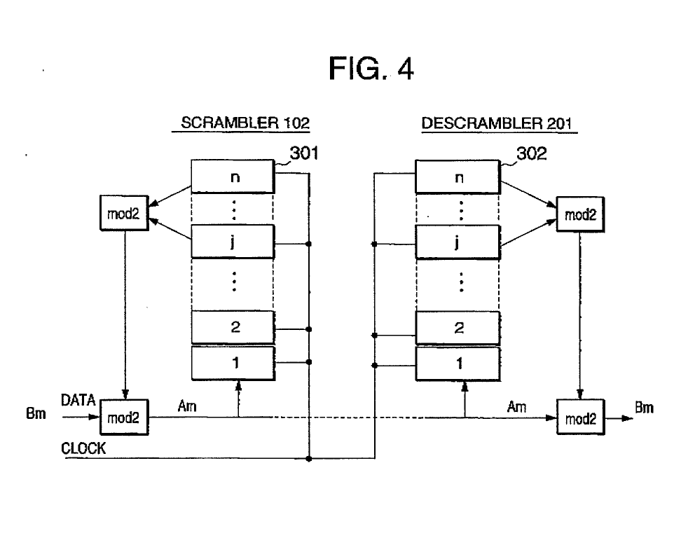

Referring to FIG. 4, the self-synchronized scrambler 102 and the self-synchronized descrambler 201 both perform M-stage feedback using N-stage shift registers 301 and 302, respectively. Assuming that no transmission error occurs, the self-synchronized scrambler 102 and the self-synchronized descrambler 201 input the same signal bit string. Accordingly, when the shift register 302 is full, the self-synchronized descrambler 201 is brought into synchronization with the self-synchronized scrambler 102.

As shown in FIG. 4, assuming that an original data sequence is Bₘ and the j-th and n-th taps are used for feedback, a scrambled data sequence is represented by Aₘ=(Bₘ+Aₘ₋ⱼ+Aₘ₋ₙ) mod 2. A descrambled data sequence is represented by Cₘ=(Aₘ+Aₘ₋ⱼ+Aₘ₋ₙ) mod 2.

Therefore, the descrambled data sequence is represented by

Cₘ=(Bₘ+Aₘ₋ⱼ+Aₘ₋ⱼ+Aₘ₋ₙ) mod 2=Bₘ,

which means that the output of the self-synchronized descrambler 201 is the same as the original data sequence Bₘ.

As described above, according to the present invention. the UDL protocol is used to map Internet Protocol (IP) on the UDL, allowing a plurality of UDL packets and ATM cells to be mixed so as to accommodate multi-traffic such as voice, moving pictures, and data.

Further, since a virtual frame is defined, in which ATM cells and UDL packets are subject to priority control, Quality of Service (QoS) can be ensured. In addition, the self-synchronized scrambling scheme allows complete transparent transmission even in the case of no physical frame of layer 1 such as the metropolitan-area WDM.

1. A virtual frame having a predetermined period, for common use in both a physical layer and a data link layer, comprising:
a universal data link (UDL) frame comprising a fixed-size header and a variable-size payload; and
an ATM (asynchronous transfer mode) cell,
wherein the fixed-size header of the UDL frame includes a length (LEN) field indicating a length of the UDL frame, a frame identification (FID) field, and a frame header error check (FHEC) field, wherein the FHEC is calculated from the LEN and the FID according to a predetermined computation method.

2. The virtual frame according to claim 1, wherein the FHEC allows UDL frame delineation to be performed independently of ATM cell delineation.

3. The virtual frame according to claim 2, wherein the FHEC 13 is located at a predetermined position of the fixed-size header, wherein a combination of the LEN and the FHEC is used for the UDL frame delineation.

4. The virtual frame according to claim 1, wherein the variable-size payload includes an extended frame header error check field, a payload data field, and a payload-CRC (cyclic redundancy check) field.

5. The virtual frame according to claim 1, further comprising:
an idle packet for filling in free space in the virtual frame.

6. The virtual frame according to claim 5, wherein the idle packet is a UDL frame consisting of the fixed-size header.

7. The virtual frame according to claim 1, further comprising:
an OAM (Operations, Administration, and Maintenance) packet for filling in free space in the virtual frame.

8. The virtual frame according to claim 1, wherein the UDL frame and the ATM cell are arranged in the virtual frame in accordance with priorities for each virtual frame.

9. The virtual frame according to claim 1, wherein a size of the fixed-size header is 5 bytes, a size of the variable-size payload is (2^{LEN}-5) bytes with a minimum size of 5 bytes and a maximum size of 2^{LEN} bytes.

10. A transmitter for use in a transmission system using a universal data link (UDL) frame comprising a fixed-size header and a variable-size payload, wherein the fixed-size header of the UDL frame includes a length (LEN) field indicating a length of the UDL frame, a frame identification (FID) field, and a frame header error check (FHEC) field, wherein the FHEC is calculated from the LEN and the FID according to a predetermined computation method, the transmitter comprising:
a multiplexer for multiplexing a plurality of UDL frames and OAM packets and/or stuff packets so that the OAM packets and/or stuff packets fill in free space among the UDL frames, to produce a virtual frame having a constant period; and
a self-synchronized scrambler for scrambling the virtual frame before transmitting.

10. The transmitter according to claim 9, wherein the multiplexer multiplexes a plurality of UDL frames, a plurality of ATM cells, and OAM packets and/or stuff packets so that the OAM packets and/or stuff packets fill in free space among the UDL frames and ATM cells, to produce a virtual frame having a constant period.

11. The transmitter according to claim 10, wherein the multiplexer multiplexes the UDL frames and the ATM cells in the virtual frame in accordance with priority control.

12. A transmitter for use in a transmission system using a universal data link (UDL) packet comprising a fixed-size header and a variable-size payload, wherein the fixed-size header of the UDL packet includes a length (LEN) field indicating a length of the UDL packet, a frame identification (FID) field, and a frame header error check (FHEC) field, wherein the FHEC is calculated from the LEN and the FID according to a predetermined computation method, the transmitter comprising:
a first buffer for storing a plurality of ATM cells mapped from an upper layer in accordance with priorities;
a second buffer for storing a plurality of UDL packets mapped from an upper layer in accordance with priorities;
a third buffer for storing a plurality of OAM packets and/or stuff packets;
a multiplexer for arranging a plurality to ATM cells sequentially read out from the first buffer and a plurality of UDL packets sequentially read out from the second buffer in a virtual frame having a constant period according to priorities, wherein OAM packets and/or stuff packets sequentially read out from the third buffer fill in free space among the UDL packets and the ATM cells; and
a self-synchronized scrambler for randomizing the virtual frame before transmitting.

13. A receiver for use in a transmission system using a universal data link (UDL) frame comprising a fixed-size header and a variable-size payload, wherein the fixed-size header of the UDL frame includes a length (LEN) field indicating a length of the UDL frame, a frame identification (FID) field, and a frame header error check (FHEC) field, wherein the FHEC is calculated from the LEN and the FID according to a predetermined computation method, the receiver comprising:
a self-synchronized descrambler for descrambling a scrambled data sequence received from a transmitter to produce a virtual frame using a clock extracted from the received scrambled data sequence, wherein the scrambled data sequence has been produced by a self-synchronized scrambler scrambling an original virtual frame according to a predetermined scrambling scheme; and
a demultiplexer for demultiplexing the virtual frame into a plurality of UDL frames and OAM packets and/or stuff packets filling in free space among the UDL frames.

14. The receiver according to claim 13, wherein the demultiplexer demultiplexes the virtual frame into a plurality of UDL frames, a plurality of ATM cells, and OAM packets and/or stuff packets filling in free space among the UDL frames and ATM cells.

15. The receiver according to claim 14, wherein the demultiplexer demultiplexes the virtual frame into the UDL frames and the ATM cells in the virtual frame in accordance with priorities.

16. A receiver for use in a transmission system using a universal data link (UDL) frame comprising a fixed-size header and a variable-size payload, wherein the fixed-size header of the UDL frame includes a length (LEN) field indicating a length of the UDL frame, a frame identification (FTD) field, and a frame header error check (FHEC) field, wherein the FHEC is calculated from the LEN and the FID according to a predetermined computation method, the receiver comprising:
a self-synchronized descrambler for descrambling a scrambled data sequence received from a transmitter to produce a virtual frame using a clock extracted from the received scrambled data sequence, wherein the scrambled data sequence has been produced by a self-synchronized scrambler scrambling an original virtual frame according to a predetermined scrambling scheme;
a demultiplexer for demultiplexing the virtual frame into a plurality of UDL frames, a plurality of ATM cells, and OAM packets and/or stuff packets filling in free space among the UDL frames and ATM cells, wherein the stuff packets are discarded;
a first buffer for storing the ATM cells in accordance with priorities;
a second buffer for storing the UDL packets in accordance with priorities; and
a third buffer for storing the OAM packets.

17. A transmission method using a universal data link (UDL) packet comprising a fixed-size header and a variable-size payload, wherein the fixed-size header of the UDL packet includes a length (LEN) field indicating a length of the UDL packet, a frame identification (FID) field, and a frame header error check (FHEC) field, wherein the FHEC is calculated from the LEN and the FID according to a predetermined computation method, the method comprising the steps of:
at a transmitter,
storing a plurality of ATM cells mapped from an upper layer in accordance with priorities;
storing a plurality of UDL packets mapped from an upper layer in accordance with priorities;
storing a plurality of OAM packets and/or stuff packets;
arranging a plurality of ATM cells sequentially read out from the first buffer and a plurality of UDL packets sequentially read out from the second buffer in a virtual frame having a constant period according to priorities, wherein OAM packets and/or stuff packets sequentially read out from the third buffer fill in free space among the UDL packets and the ATM cells;
randomizing the virtual frame to produce a data sequence;
transmitting the data sequence;
at a receiver,
receiving a data sequence from the transmitter;
extracting a clock from the received data sequence;
descrambling the received data sequence to produce a virtual frame using the clock;
demultiplexing the virtual frame into a plurality of UDL frames, a plurality of ATM cells, and OAM packets and/or stuff packets filling in free space among the UDL frames and ATM cells; and
discarding the stuff packets.

18. A transmission method using a universal data link (UDL) packet comprising a fixed-size header and a variable-size payload, wherein the fixed-size header of the UDL packet includes a length (LEN) field indicating a length of the UDL packet, a frame identification (FID) field, and a frame header error check (FHEC) field, wherein the FHEC is calculated from the LEN and the FID according to a predetermined computation method, the method comprising the steps of:
storing a plurality of ATM cells mapped from an upper layer in accordance with priorities;
storing a plurality of UDL packets mapped from an upper layer in accordance with priorities;
storing a plurality of OAM packets and/or stuff packets;
arranging a plurality of ATM cells sequentially read out from the first buffer and a plurality of UDL packets sequentially read out from the second buffer in a virtual frame having a constant period according to priorities, wherein OAM packets and/or stuff packets sequentially read out from the third buffer fill in free space among the UDL packets and the ATM cells;
randomizing the virtual frame to produce a data sequence;
transmitting the data sequence to a receiver.
